(19) United States
(12) Patent Application Publication
(10) Pub. No.: US 2016/0381646 A1
(43) Pub. Date: Dec. 29, 2016

(54) METHOD AND SYSTEM FOR HIGH DENSITY WI-FI COMMUNICATIONS

(71) Applicants: Qinghua LI, San Ramon, CA (US); Xintian E. LIN, Mountain View, CA (US); Yu ZHOU, Beijing (CN); Hunjun YIN, Saratoga, CA (US); Xianchao XU, Beijing (CN); Honggang LI, Beijing (CN); Wendy C. WONG, San Jose, CA (US); Feng XUE, Redwood City, CA (US); Rongzhen YANG, Shanghai (CN)

(72) Inventors: Qinghua LI, San Ramon, CA (US); Xintian E. LIN, Mountain View, CA (US); Yu ZHOU, Beijing (CN); Hunjun YIN, Saratoga, CA (US); Xianchao XU, Beijing (CN); Honggang LI, Beijing (CN); Wendy C. WONG, San Jose, CA (US); Feng XUE, Redwood City, CA (US); Rongzhen YANG, Shanghai (CN)

(21) Appl. No.: 15/038,720

(22) PCT Filed: Dec. 21, 2013
(86) PCT No.: PCT/US2013/077352

§ 371 Date: May 23, 2016

(51) Int. Cl. H04W 52/50; H04W 74/08; H04W 52/36

(52) U.S. Cl. CPC H04W 52/50; H04W 52/36; H04W 74/0816; H04W 84/12

(57) ABSTRACT

Examples are disclosed for a system to improve wireless spectral efficiency, including a processor, a memory coupled to the processor, a radio coupled to the processor component, one or more antennas coupled to the radio, wireless logic to be executed on the processor component to: process reception of a higher-power request to send (RTS) signal from an initiator by an initiator's receiver; process transmission of a higher-power clear to send (CTS) signal to the initiator, to set a lower-power transmit opportunity (TXOP); and process reception of an invitation to share the TXOP at lower power, the invitation comprising an indication that devices that receive the invitation should transmit at lower power during a time period indicated by the higher-power CTS signal; and a timer to track progress of the time period.

### TECHNICAL FIELD

Examples described herein are generally related to high-capacity wireless networking via power control.

### BACKGROUND

The indoor radio environment is often dominated by computing devices having wireless capabilities that communicatively couple to other such devices having wireless capabilities and/or to an access point of a wireless local area network (“WLAN”) using wireless technologies such as the Institute of Electrical and Electronic Engineers (IEEE) 802.11™ WLAN family of specifications (e.g., sometimes referred to as “Wi-Fi®”), known formally as the IEEE Standard for Information technology—Telecommunications and information exchange between systems—Local and metropolitan area networks—Specific requirements Part 11: WLAN Media Access Controller (MAC) and Physical Layer (PHY) Specifications, published March 2012, and/or later versions of this standard (“IEEE 802.11 Standard”). Also, wireless technologies designed to operate in a 60 GHz communication band, such as IEEE 802.11ad, known formally as Amendment 3: Enhancements for Very High Throughput in the 60 GHz Band, IEEE Std 802.11ad™-2012 (Amendment to IEEE Std 802.11™-2012, as amended by IEEE Std 802.11ae™-2012 and IEEE Std 802.11aa™-2012) (sometimes referred to as “WiGig®”) may allow wireless capable devices to replace wired interconnects with high speed and relatively short range wireless interconnects via a process typically referred to as wireless docking. The high speed and relatively short range wireless interconnects using wireless technologies such as WiGig may allow wireless devices to wirelessly dock with devices having one or more input/output devices such as a display, a keyboard, a network interface card, a mouse or a storage device. In some examples, once wirelessly docked, the wireless device may utilize the one or more input/output devices in a same manner as when connected to a wired or physical docking station.

In situations that include dense network environments with large numbers of access points and stations, a transmitter that transmits at an excessively high power level may interfere with unintended receivers that are farther away than the intended receiver. Therefore, a need exists to provide improved spectral reuse and concomitant capacity improvements.

### BRIEF DESCRIPTION OF THE DRAWINGS

FIG. 1A illustrates an example of higher-power wireless communications.

FIG. 1B illustrates an example of lower-power wireless communications.

FIG. 2 illustrates an example of wireless communications.

FIG. 3 illustrates an example of a processes.

FIG. 4 is a diagram of an IEEE 802.11 header as known in the art.

FIG. 5 illustrates an example of a block diagram for an apparatus.

FIG. 6 illustrates an example of a device.

### DETAILED DESCRIPTION

Request to Send (RTS) and Clear to Send (CTS) are components of a mechanism used by the IEEE 802.11 wireless networking protocol to reduce frame collisions introduced by the hidden node problem. A node wishing to send data initiates the process by sending an RTS frame. The destination node replies with a CTS frame. Any other node receiving the RTS or CTS frame should refrain from sending data for a predetermined time, thus solving the hidden node problem. The amount of time the node should wait before trying to get access to the medium is indicated in both the RTS and the CTS frame. The RTS frame contains the amount of time that the other nodes should wait. The wait time is often called the back-off time. The duration field within the RTS frame indicates the amount of time in microseconds needed to transmit data or management+CTS+ACK+SIFS interval. The CTS frame includes a duration field with the amount of time in microseconds, obtained by the previous RTS minus time need to transmit CTS and its short interframe space (SIFS) interval. When combined with an ACK, any wireless node overhearing the exchange of RTS/CTS will cease to transmit during this period.

Examples are generally directed to improvements for wireless and/or mobile devices to improve overall capacity in an area that is densely populated with wireless communication devices. The wireless technologies may be associated with Wi-Fi or WiGig. These wireless technologies may include establishing and/or maintaining wireless communication links through various frequency bands to include Wi-Fi and/or WiGig frequency bands, e.g., 2.4, 5 or 60 GHz. These wireless technologies may also include wireless technologies suitable for use with mobile devices or user equipment (UE) capable of coupling to other devices via a WLAN or via a peer-to-peer (P2P) wireless connection. For example, mobile devices and the other device may be configured to operate in compliance with various standards promulgated by the Institute of Electrical and Electronic Engineers (IEEE). These standards may include Ethernet wireless standards (including progenies and variants) associated with the IEEE Standard for Information technology—Telecommunications and information exchange between systems—Local and metropolitan area networks—Specific requirements Part 11: WLAN Media Access Controller (MAC) and Physical Layer (PHY) Specifications, published March 2012, and/or later versions of this standard (“IEEE 802.11 Standard”).

In some examples various IEEE standards associated with the IEEE 802.11 Standard such as IEEE 802.11a/b/g/n, IEEE 802.11ac or IEEE 802.11ad may be utilized by mobile devices or other devices to establish or maintain WLAN and/or P2P communication links and/or establish wireless communications with each other (e.g., wireless accessing). These other devices may have one or more input/output devices to possibly be used by mobile devices upon wirelessly access. The other devices may include wireless access capabilities and may include, but are not limited to, a docking device, a smart phone, a smart television, smart audio speakers, a notebook computer, a tablet computer, a netbook computer, other small computing devices (e.g., Ultrabook™ device—Ultrabook is a trademark of Intel Corporation in the U.S. and/or other countries), desktop computer, a workstation computer, a server, a handheld gaming device, a gaming console, a handheld media player or a media player console. The one or more input/output devices may either be integrated with the other devices or may be coupled via one or more wired and/or wireless connections.

Wireless technology such as Wi-Fi or WiGig, when used for communication with display devices (e.g., an HDTV) may be referred to herein as Wireless Display (WiDi) technology.

As Wi-Fi deployment density increases, interference becomes the limiting factor for throughput performance. In various embodiments, it may be advantageous to enhance the efficiency and performance of wireless local area network (WLAN) deployments, for instance in situations that include dense network environments with large numbers of access points and stations. Dense network environments may benefit from transmission power control for improved spectral reuse and concomitant capacity improvements. A WLAN employing such enhancements may be known as a high efficiency WLAN (HEW). The IEEE 802.11 High Efficiency WLAN study group has been formed to study this problem. Power control can be an efficient way to reduce interference. Traditional power control is suitable for Wi-Fi nodes operating in infrastructure mode in an office environment, in which a central node (e.g., a base station) controls transmit power levels of end devices.

However, it is challenging to implement power control for non-infrastructure mode, in which end devices control their own transmit powers. Nodes operating in a non-infrastructure mode (e.g., using Wi-Fi protocol) may use transmission powers that are much lower than those of infrastructure mode (e.g. 20 dBm lower) because of the short operating range. A non-infrastructure mode may reduce its transmission power if there is no legacy device nearby, and the non-infrastructure mode may use full power otherwise.

A problem with non-infrastructure mode is that, if an end device reduces its transmission power, its neighbor will receive a weak signal. The neighbor may interpret the weak signal as an indication that the transmitter is far away, and thus will transmit at a higher-power level. The higher-power transmission will interfere with nearby lower-power transmission, since a lower-power transmission will be more vulnerable to interference than a higher-power transmission. If this problem is not controlled, no device will reduce its transmission power and all transmitters will transmit at higher power. This is analogous to a large gathering in a room such as a party, in which the loudness of conversations in the room may continually increase until everyone is shouting to be heard.

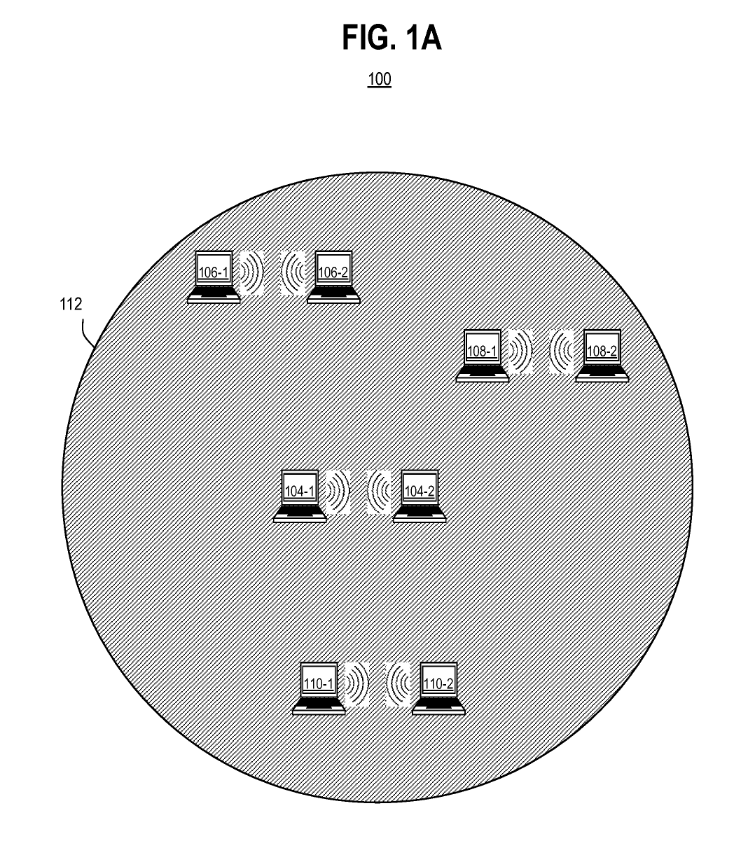

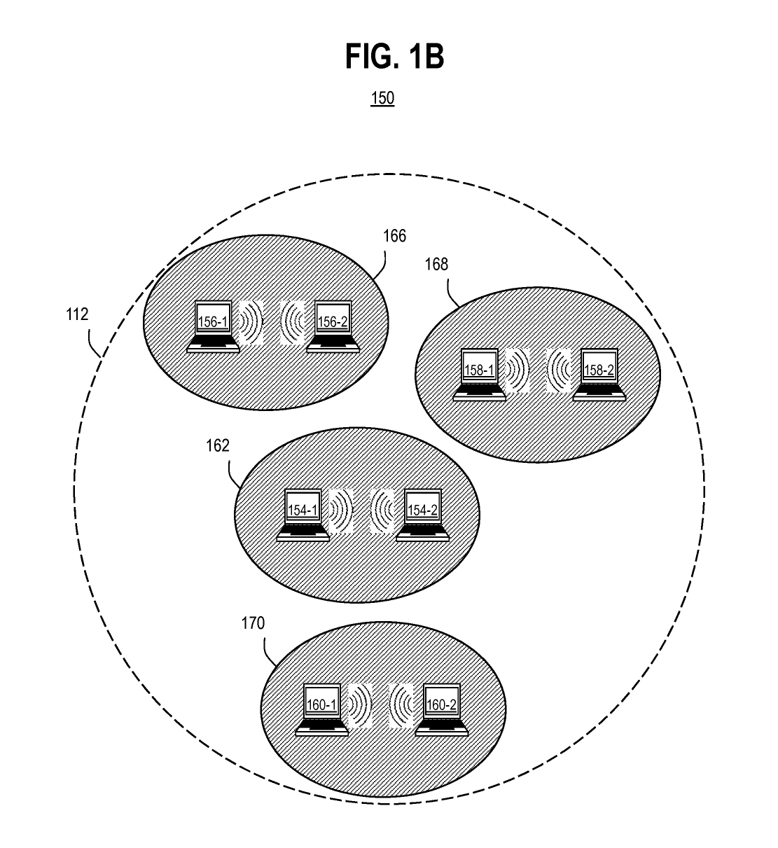

This problem is illustrated by scenario 100 in FIG. 1A. Nodes 104-1 and 104-2 represent two communication devices that may communicate via Wi-Fi signals at higher power, which reaches throughout coverage area 112. Nodes 104-1 and 104-2 used higher-power RTS/CTS signals to reserve their use of coverage area 112, and communicate by use of higher-power signals. The higher-power signals prevent device pairs 106-1, 106-2, 108-1, 108-2, 110-1 and 110-2 from communicating due to excessive interference. Nodes 104-1 and 104-2, and device pairs 106, 108 and 110 may represent substantially any Wi-Fi communication device, such as laptops, tablets, PCs, smart phones, gaming devices, cameras, camcorders, TVs, etc.

In contrast, FIG. 1B illustrates spectral and/or spatial reuse and attendant capacity increase that may be possible by use of embodiments in accordance with the present disclosure. After nodes 154-1 and 154-2 reserve coverage area 112 for lower-power communication, communication between nodes 154-1 and 154-2 proceeds using lower-power signals that have smaller coverage area 162. The smaller coverage area 162 allows device pairs 156, 158 and 160 to communicate lower-power signals within coverage areas 166, 168 and 170, respectively, thereby providing higher overall capacity through spectral and/or spatial reuse. Embodiments are described in further detail below.

Embodiments in accordance with the present disclosure provide a simple solution to enable lower power transmissions coexisting with legacy full power devices. Testing has shown that embodiments are able to at least double throughput of three Wi-Fi pairs that are co-located with legacy devices.

Conventional Wi-Fi depends upon a collision sense multiple access (CSMA) protocol that assumes that interference is reciprocal. Reciprocity relies on two assumptions: first, that the wireless channel is reciprocal, e.g., the loss from A to B is the same as the loss from B to A. Second, reciprocity assumes that the transmission power of both device A and device B are the substantially the same. Together, reciprocity implies that if device “A” overhears a signal for device “B” with a received power level, then device A predicts that its signal level received by device B is at the same received power level when device A transmits. If transmission powers are different among devices in a network, the CSMA mechanism does not work well and interference among link A-B and other links will occur.

Embodiments in accordance with the present disclosure provide a process for transmit power control that provides a higher level of backward compatibility and lower implementation complexity. Embodiments include the following actions:

First, reserve the channel for lower power transmission using full power reservation packet exchange, e.g., RTS/CTS. The reservation will prevent nearby higher-power legacy devices from interfering with lower-power transmissions.

Second, allow lower-power transmissions that use the same power level to share a reserved channel using legacy CSMA processes. Sharing the reserved channel increases capacity via parallel, lower-power, higher spatial and/or frequency reuse.

Embodiments in accordance with the present disclosure are applicable to both infrastructure and non-infrastructure modes. In addition, embodiments boost throughput even in the presence of nearby legacy devices. Embodiments are designed for higher density scenarios such as hot spot and office or residential environments that are mixed with infrastructure and device-to-device (D2D) links, e.g., peer connections. Testing of embodiments has demonstrated a factor of two gain in throughput when coexisting with legacy devices.

Embodiments in accordance with the present disclosure protect lower power transmissions that are vulnerable to legacy interferers, while enabling parallel lower power transmissions for higher spatial reuse and higher throughput.

### Backward Compatibility and Lower Complexity.

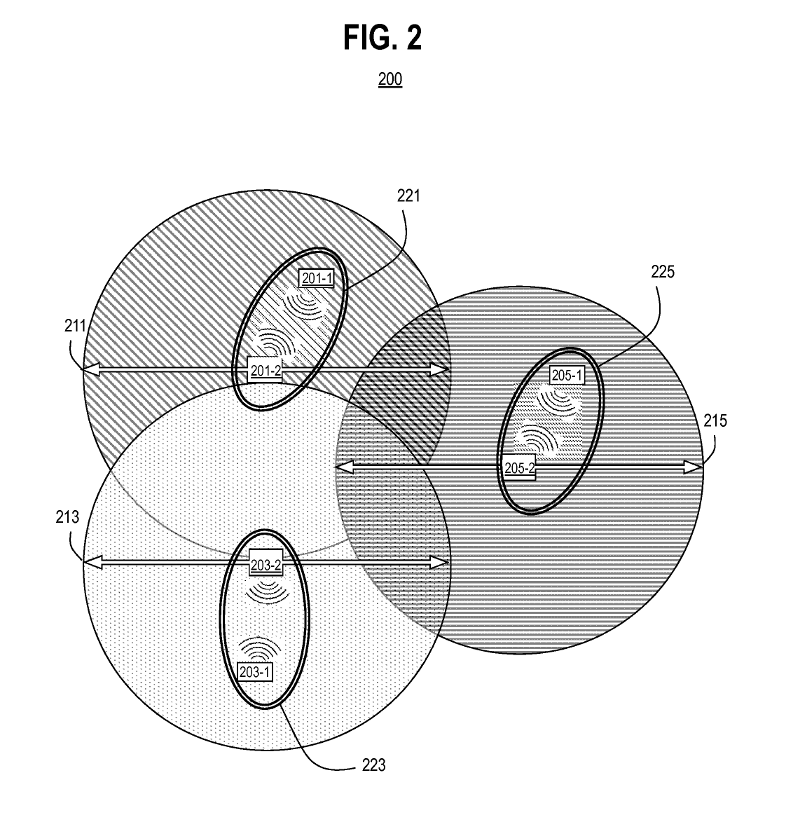

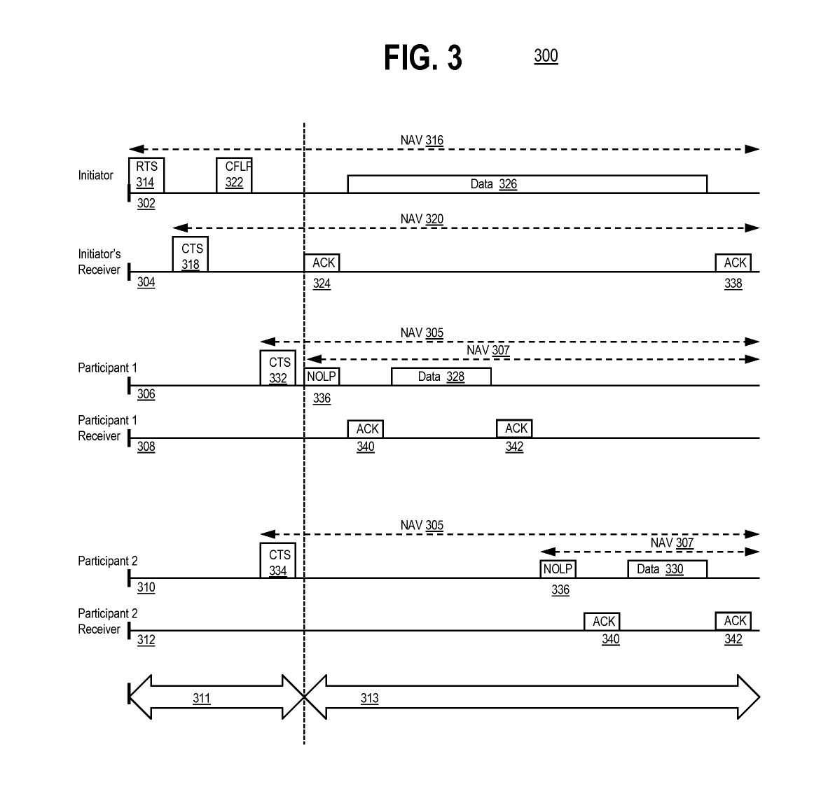

Embodiments in accordance with the present disclosure provide backward compatibility and lower implementation complexity. Operations are illustrated in FIG. 2 and FIG. 3, which illustrate three lower power links. In particular, FIG. 2 illustrates a large protection regions 211, 213, 215 created by higher-power CTS signals and small interference footprints 221, 223, 225 created by lower-power transmissions, as described below in greater detail.

To maximize backward compatibility, embodiments use a lower-power transmission opportunity (TXOP) for lower power transmissions, the TXOP being a time-space resource in the Wi-Fi channel. In addition, the power level within the TXOP is restricted to a below a relatively lower limit for all lower power participants, e.g., 10 dB-30 dB below maximum power. The relatively lower limit results in interference reciprocity that the CSMA protocol assumes. Therefore, legacy Wi-Fi implementation can be reused as long as the transmission power is limited to the relatively lower limit in the TXOP.

The finite-state machine model of the transceiver and clear channel assessment (CCA) operation of the transceiver remains the same for the lower power operations. CCA is part of CSMA operation, and refers to a process in which a transceiver measures received signal power in a channel. If the received signal power passes a predetermined threshold, the transceiver determines that the channel is in use by another transmitter and suspends its back-off countdown. Otherwise, the receiver determines that the channel is idle and continues its back-off countdown.

If it is not important to maintain backward compatibility, the transmission power level may be relaxed such that the interference to other scheduled lower-power devices is negligible at least to the initiator of the TXOP, and that the link quality of the reduced transmission power can be met.

### Initialization of Lower-Power TXOP.

Embodiments in accordance with the present disclosure may establish the lower-power TXOP by a lower-power transmitter that acquires a channel (e.g., via contention). FIG. 2 illustrates configuration 200 in accordance with an embodiment of the present disclosure. A transmitter and receiver that first establish the TXOP are referred to as an initiator and an initiator's receiver, respectively, and collectively referred to as an initiator pair. Configuration 200 illustrates an initiator 201-1 and an initiator's receiver 201-2 that have established a protection region 211 around initiator's receiver 201-2. FIG. 2 further illustrates a first participant 203-1 and a first participant's receiver 203-2, and a second participant 205-1 and a second participant's receiver 205-2. Protection region 213 is formed by first participant's receiver 203-2, and protection region 215 is formed by second participant's receiver 205-2. Initiator 201-1 and initiator's receiver 201-2 are able to communicate at lower power within small interference footprint 221. First participant 203-1 and first participant's receiver 203-2 are able to communicate at lower power within small interference footprint 223. Second participant 205-1 and second participant's receiver 205-2 are able to communicate at lower power within small interference footprint 225.

FIG. 3 illustrates a message exchange scenario 300 that may be used to establish configuration 200. Scenario 300 includes timeline 302 to illustrate messages sent by initiator 201-1, timeline 304 to illustrate messages sent by initiator's receiver 201-2, timeline 306 to illustrate messages sent by first participant 203-1, timeline 308 to illustrate messages sent by first participant's receiver 203-2, timeline 310 to illustrate messages sent by second participant 205-1 and timeline 312 to illustrate messages sent by second participant's receiver 205-2. During period of time 311, lower power zones are initialized at full-power for protection against full-power legacy devices. “Full-power” is an example of “higher-power,” and higher power is relative to a “lower-power” signal. Period of time 313 is a lower-power communication period, which is contention-free for the initiator of a device-to-device pair, and which further features lower-power contention and transmission for other participants.

The initiator 201-1 and the initiator's receiver 201-2 first acquire the channel by a full power RTS 314/CTS 318 channel reservation packet exchange. The full-power channel reservation prevents any legacy full-power transmission from interfering with subsequent lower-power communications of the initiator pair 201. Otherwise, a lower transmission power for the channel reservation may cause a legacy receiver to fail to receive the CTS 318 packet and thus send a full-power packet that would interfere with subsequent lower power transmission. The channel is reserved for a duration specified in network allocation vectors (NAV) 316 and 320 that are interpreted from the RTS 314 and CTS 318 packets, respectively. NAVs are interpreted by a MAC layer from a duration field in a MAC header of a carrying packet (e.g., RTS 314 or CTS 318). Since different devices send packets at different times, the duration fields are different but they terminate at substantially the same time in embodiments described herein.

### Call for Lower Power Participant.

After acquiring the channel, the initiator 201-1 may share the reserved channel by inviting other lower-power pairs in order to provide increased spatial reuse and throughput. The initiator 201-1 signals the invitation to nearby lower-power transmitters, for example by use of a new packet type—call for lower power (CFLP) 322 packet—as illustrated in FIG. 3. In some embodiments, initiator 201-1 may transmit CFLP 322 at higher power so that more neighbors may join the lower-power zone. In other embodiments, initiator 201-1 may transmit CFLP 322 at lower power in order to reduce the spatial size of the lower-power zone for the fairness between lower power device and legacy device. The CFLP 322 packet informs nearby transmitters (e.g., first participant 203-1, first participant's receiver 203-2, second participant 205-1, second participant's receiver 205-2), that subsequent data packets will be sent by a lower transmission power and that other lower power transmitters are welcome to share the channel. The desired transmission power level of the lower power data is specified in the CFLP 322 packet so that participating lower-power pairs can reuse the CSMA mechanism with a reduced power level for accessing the channel.

In another embodiment, an existing packet type may be used to signal the invitation. For example, the initiator 201-1 may send a data packet (e.g., RTS 314) addressed to itself, which specifies the invitation and the desired power level. In another example, the initiator's receiver 201-2 may send a self-addressed CTS packet (“self-CTS”) multiple times for signaling the invitation. Nearby transmitters that receive the same packets may adjust their transmit powers accordingly. The nearby transmitters receiving the self-CTS packets may infer that it is an invitation because the same self-CTS had been received multiple times in a row.

After receiving the invitation (e.g., the CFLP 322 packet), a lower-power transmitter (e.g., first participants 203-1, 203-2, second participants 205-1, 205-2) knows it is invited. The transmitter may join the lower-power TXOP by meeting both of the two conditions below.

The first condition is that no devices other than the initiator are prohibiting the participant device from transmitting, e.g., by having reserved the TXOP for use by other devices. In Wi-Fi for example, a CTS packet may reserve a channel via a duration field in the CTS packet. After receiving the duration field, devices set their respective NAVs such that they will not start their transmissions until the respective NAVs expire, thus preventing interference to ongoing transmissions. For example, if the participant has an unexpired NAV set by a legacy device, the participant may refrain from sending full power packet before the NAVs expire, and thus does not join the current lower-power TXOP right away. Therefore, after receiving the CFLP packet, the receiver should check whether the initiator is the only device that has reserved the channel. If so, the receiver can join the lower-power TXOP. Otherwise, if another device also has set a blocking NAV that is unexpired, the receiver may wait until the blocking NAV expires and then send a lower-power packet without first sending a full-power CTS packet.

However, the receiver of the CFLP risks losing the lower-power packet if it does not send, right after the CFLP, a higher-power CTS packet to block transmissions from nearby legacy devices. However, if the receiver is blocked by some other device at that time from sending a higher-power CTS packet, the receiver may still transmit lower power packets at its own risk without protection against legacy interference. These packets may be received with lower quality or lower probability.

In another example, if the participant has an unexpired NAV set by a nearby lower-power device, the participant should also respect that lower-power transmission and should not send a full-power packet until the NAV set by the lower-power device expires. Although the receiver initially may be blocked from joining a lower-power TXOP, the receiver may still join the lower-power TXOP after the unexpired NAV expires by sending a lower-power packet without a full power protection packet. For example, no full-power protection packet, e.g. the duplicated CTS, would be sent and the receiver risks losing the lower-power packet.

The second condition is that the transmitter has at least some data to send and can use at least a certain portion of the TXOP duration, e.g., one-third of the TXOP duration. In order to prevent interference from other devices, the participant may send a full-power CTS to reserve the channel for the entire TXOP duration, during which the transmitter may join the lower-power TXOP as a participant. However, the transmitter may waste a portion of the reserved channel if the transmitter does not have enough data to send to fill the TXOP.

### Simultaneous Protection of Lower Power Participants.

Similar to the initiator, the lower-power participant may need to prevent legacy full-power transmission from interfering with its lower power communications. The lower-power participant may reserve the channel by sending a CTS packet (e.g., CTS 332) in full power. NAV 305 is interpreted from the duration field in CTS 332. The geographic area or physical space in which the channel is reserved may be known as a protection region. The union of the protection regions generated by the initiator and participants is the effectively the overall protection region of the lower-power TXOP. Since there may be multiple participants, their CTS packets (e.g., 332 and 334) may collide. The contention and collision of the CTS packets may consume large overhead if many devices want to join the TXOP.

Embodiments in accordance with the present disclosure solve this problem as illustrated in the left portion of FIG. 3, as shown in timelines 306, 308, 310 and 312, at which the first participant pair and the second participant pair send their first packets. The channel reservations of all participants are made simultaneously using one CTS duration. To avoid mutual interference, the participants send CTS packets 332, 334 that are substantially identical at a physical networking layer. In addition, the CTS packets 332, 334 are sent simultaneously within the cyclic prefix (CP) duration in a short inter-frame (SIF) duration after the CFLP 322 packet. This scheme may be extended to additional participant pairs beyond what is depicted in FIG. 3.

To make sure that the physical signals of the CTS packets 332, 334 are substantially the same, participants 203-1 and 205-1 duplicate the CTS packet sent by the initiator's receiver 201-2. The PHY/MAC fields and modulation coding scheme are substantially exactly duplicated. Therefore, the transmitted signals are substantially physically the same, and they are superimposed over the air as if the number of multipath channels had been increased. Other devices can then receive the superimposed, duplicated CTSs correctly as if the CTS had been sent by one device. As a result, the channel reservation of the participants is then completed within one CTS packet duration without collisions. After the duplicated CTSs, all transmissions are in lower power mode until the lower-power TXOP terminates by time out or contention-free end packet.

### Confirmation of Lower Power Setting.

Optionally, some embodiments may confirm the lower-power setting. In the lower-power TXOP, all transmissions from both the initiator 201-1 and the participant pairs 203, 205 should be at the power level specified by the initiator 201-1, e.g., as specified in the CFLP 322 packet. If one receiver, e.g. initiator's receiver 201-2 or participant's receiver 203-2 or 205-2, does not correctly receive the power level specified in the CFLP 322 packet, the receiver may send a full-power acknowledgment (ACK) by default for acknowledging the received data packet in the lower-power TXOP. The full-power ACK would interfere the other lower-power communications. Although this may happens with a lower probability, it may be still desirable to prevent it. There are two options.

The first option is to ignore this problem. Since the communications distances of lower power devices are usually short, the transmitter and receiver should be able to hear the power setting (e.g., in the CFLP 322 packet) correctly most of the time. The participant (e.g., 203-1 or 205-1) does not need to send the power setting individually to its respective receiver (e.g., 203-2 or 205-2) again. In addition, since the initiator's receiver 201-2 and the participant's receiver 203-2 or 205-2 do not need to acknowledge receiving the power level, overhead is reduced at the cost of robustness.

The second option is for the participant to send the power setting to its receiver individually to make sure the data ACK will be in lower power. There are two sub-options for this. The first sub-option is that the power setting may be sent in a dedicated, notification of lower power (NOLP) 336 packet. If a NOLP 336 packet is sent, the receiver should acknowledge the NOLP 336 packet. NAV 307 is interpreted from a duration field in NOLP 336.

In some embodiments, initiator 201-1 may also transmit NOLP 336 to its receiver 201-2. The CFLP 322 already includes the information from NOLP 336, so if initiator's receiver 201-2 has received CFLP 322, receiver 201-2 need not also receive NOLP 336. However, ACK 324 to confirm reception of CFLP 322 will be in lower power, so if initiator 201-1 does not receive ACK 324 or if the initiator's receiver 201-2 misses receiving CFLP 322, then the sending of NOLP 336 by initiator 201-1 to its receiver 201-2, before sending data packets 326, will provide additional assurance of lower-power operation.

The second sub-option is that an acknowledgement may be piggy-backed onto another message, e.g., combined with another message. If the second sub-option is used, the receiver may directly send the ACK of the data packet at the specified power level without separately acknowledging the power setting. If the data and power setting are correctly received, only a lower-power ACK will be sent. If the power setting is lost, then the packet is lost as well. In that case, the second sub-option saves overhead because no full power ACK will be sent.

In FIG. 3, the second packet sent by initiator's receiver 201-2 is an ACK 324. This ACK 324 confirms that the power setting is correctly received and the lower-power transmission can start. Also in FIG. 3, the second packet of first participant 203-1 and second participant 205-1 is an NOLP 336 packet to its respective receiver. The NOLP 336 packet specifies the power level and the remaining duration of the lower-power TXOP. After receiving the NOLP 336 packet, the addressed receiver sends an ACK 340 using the specified power level.

After ACK 324 is sent, lower-power communication between initiator 201-1 and 201-2 may occur during data period 326. After ACK 340 is sent, lower-power communication between participants 203-1, 205-1 and respective participant's receiver 203-2, 205-2 may then proceed during respective data periods 328, 330.

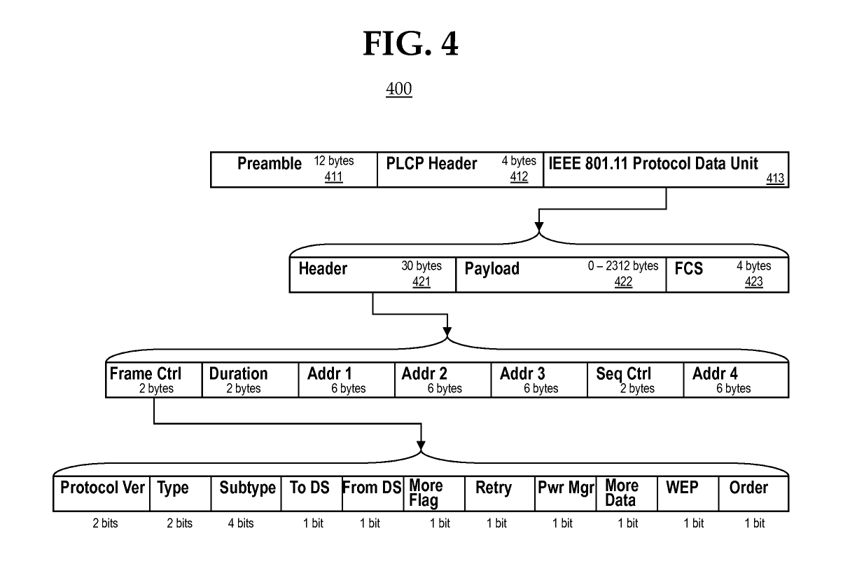

Transmission of the new or modified messages described herein, e.g., CFLP 322, CTS 332, 334, NOLP 336, may be accomplished by use of known wireless communication protocols such as Wi-Fi. Wi-Fi is a frame-based communication protocol. FIG. 4 illustrates an IEEE 802.11 frame format 400 as known in the art. A transmitted signal conforming to frame format 400 may be referred to as a packet. Frame format 400 may be divided into a twelve-byte preamble field 411, a four-byte physical layer convergence procedure (“PLCP”) header field 412, and a variable-length protocol data unit (“PDU”) field 413. PDU field 413 may be further subdivided into a thirty-byte header field 421, a variable-length payload field 422, and a four-byte frame check sequence (“FCS”) field 423. Payload field 422 may vary in length between zero and 2,312 bytes. Therefore, the minimum length for frame format 400 is fifty bytes when the payload field 422 is of zero length. Payload field 422 may be used to transport the new messages such as ROS/COS and HEW OSV.

Embodiments in accordance with the present disclosure provide a distributed TPC process that may be used to improve the performance of WLAN communication systems. Embodiments provide an improved process for simultaneous transmission for spatial reuse and backward compatibility with legacy Wi-Fi devices.

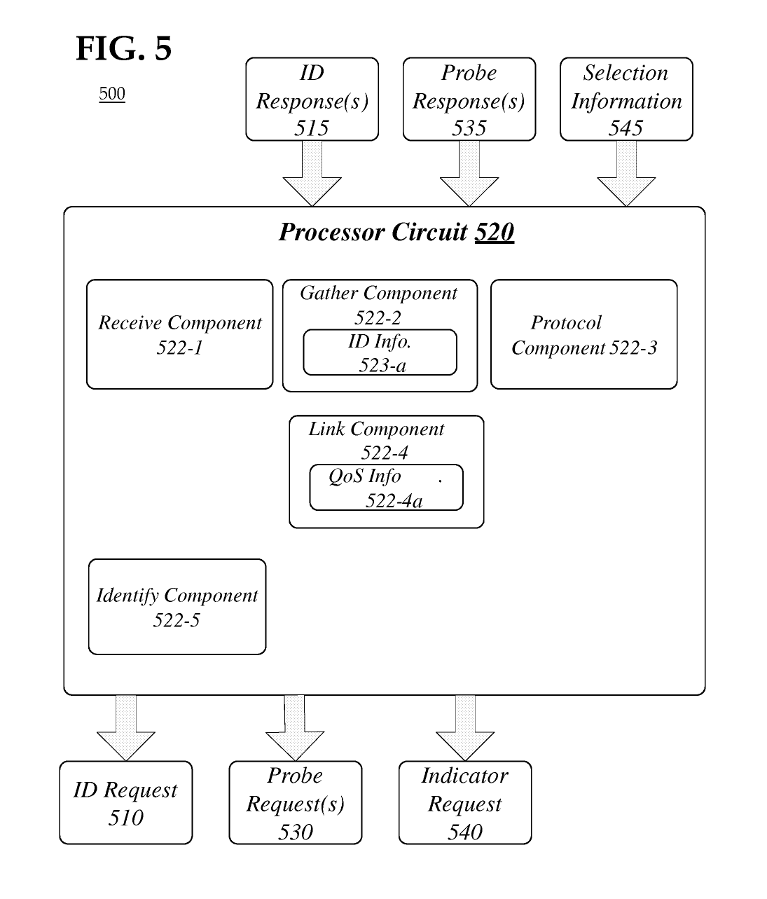

FIG. 5 illustrates a block diagram for a first apparatus. As shown in FIG. 5, the first apparatus includes an apparatus 500. Although apparatus 500 shown in FIG. 5 has a limited number of elements in a certain topology or configuration, it may be appreciated that apparatus 500 may include more or less elements in alternate configurations as desired for a given implementation.

Apparatus 500 may be usable as Wi-Fi enabled mobile device 102, base station 104, slave Wi-Fi enabled mobile device 106 and/or base station 108 illustrated in FIG. 1.

The apparatus 500 may comprise a computer and/or firmware implemented apparatus 500 having a processor circuit 520 arranged to execute one or more components 522-a. It is worthy to note that “a” and “b” and “c” and similar designators as used herein are intended to be variables representing any positive integer. Thus, for example, if an implementation sets a value for a=5, then a complete set of components 522-a may include modules 522-1, 522-2, 522-3, 522-4 or 522-5. The embodiments are not limited in this context.

According to some examples, apparatus 500 may be part of a mobile device that may be capable of operating in compliance with one or more wireless technologies such as those described in or associated with the IEEE 802.11 standards. For example, the mobile device having apparatus 500 may be arranged or configured to wirelessly couple to a Wi-Fi access point or another Wi-Fi communication device.

In some examples, as shown in FIG. 5, apparatus 500 includes processor circuit 520. Processor circuit 520 may be generally arranged to execute one or more components 522-a. The processor circuit 520 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Dual microprocessors, multi-core processors, and other multi-processor architectures may also be employed as processor circuit 520. According to some examples processor circuit 520 may also be an application specific integrated circuit (ASIC) and components 522-a may be implemented as hardware elements of the ASIC.

According to some examples, apparatus 500 may include a receive component 522-1. Receive component 522-1 may be executed by processor circuit 520 to receive Wi-Fi probe responses and/or other communication messages in accordance with embodiments of the present disclosure.

In some examples, apparatus 500 may also include a gather component 522-2. Gather component 522-2 may be executed by processor circuit 520 to gather identification information from one or more devices capable of wirelessly communicating with the mobile device. Gather component 522-2 may gather identification information included locations of Wi-Fi access points and/or other Wi-Fi devices and at least temporarily store the gathered identification information with ID information 523-a. According to some examples, gather component 522-2 may maintain ID information 523-a in a data structure such as a lookup table (LUT).

In some examples, apparatus 500 may also include a link component 522-4. Link component 522-4 may be executed by processor circuit 520 to determine link conditions (e.g., interference, collisions, etc.) between the mobile device and the one or more devices based on a technique utilizing the Wi-Fi frequency band. Information associated with operation of or measurements by link component 522-4 may be stored as QoS information 522-4a. According to some examples, distance information 522-4a may be maintained in a LUT or other type of data structure.

In some examples, apparatus 500 may also include a protocol component 522-3. Protocol component 522-3 may be executed by processor circuit 520 in order to communicate on a protocol level or layer with other devices. For example, protocol component 522-3 may interpret incoming messages, may gather and/or analyze data such as link conditions that may be needed to practice the embodiments, and may formulate outgoing messages in accordance with the protocols described herein.

According to some examples, apparatus 500 may also include an identify component 522-5. Identify component 522-5 may be executed by processor circuit 520 to identify the given device from among the one or more devices based on predetermined criteria.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

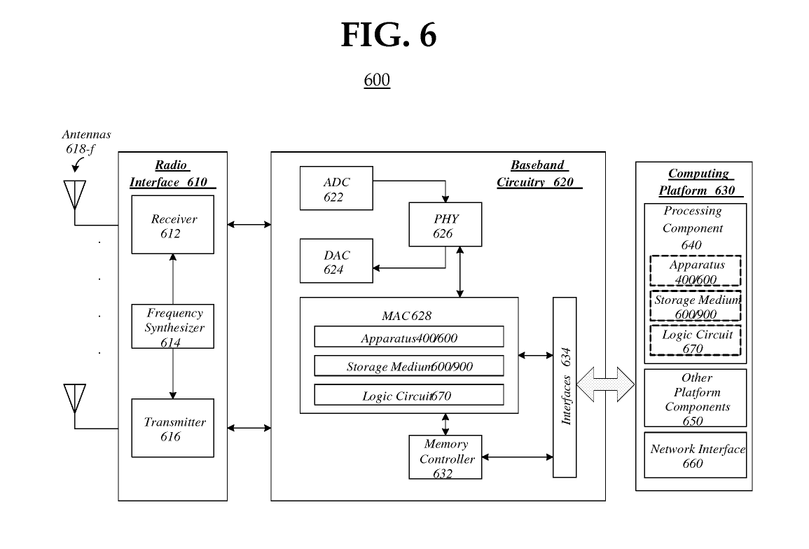

FIG. 6 illustrates an embodiment of a device 500. In some examples, device 600 may be configured or arranged for wireless communications in a wireless network. Device 600 may implement, for example, a Wi-Fi access point, a storage medium and/or a logic circuit 670. The logic circuit 670 may include physical circuits to perform operations described for other apparatus. As shown in FIG. 6, device 600 may include a radio interface 610, baseband circuitry 620, and computing platform 630, although examples are not limited to this configuration.

The device 600 may implement some or all of the structure and/or operations for apparatus, storage medium 600/900 and/or logic circuit 670 in a single computing entity, such as entirely within a single device. The embodiments are not limited in this context.

Radio interface 610 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 610 may include, for example, a receiver 612, a transmitter 616 and/or a frequency synthesizer 614. Radio interface 610 may include bias controls, a crystal oscillator and/or one or more antennas 618-f. In another embodiment, radio interface 610 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 620 may communicate with radio interface 610 to process receive and/or transmit signals and may include, for example, an analog-to-digital converter 622 for down converting received signals, a digital-to-analog converter 624 for up converting signals for transmission. Further, baseband circuitry 620 may include a baseband or physical layer (PHY) processing circuit 626 for PHY link layer processing of respective receive/transmit signals. Baseband circuitry 620 may include, for example, a processing circuit 628 for medium access control (MAC)/data link layer processing. Baseband circuitry 620 may include a memory controller 632 for communicating with MAC processing circuit 628 and/or a computing platform 630, for example, via one or more interfaces 634.

In some embodiments, PHY processing circuit 626 may include a frame construction and/or detection module, in combination with additional circuitry such as a buffer memory, to construct and/or deconstruct communication frames (e.g., containing subframes). Alternatively or in addition, MAC processing circuit 628 may share processing for certain of these functions or perform these processes independent of PHY processing circuit 626. In some embodiments, MAC and PHY processing may be integrated into a single circuit.

Computing platform 630 may provide computing functionality for device 600. As shown, computing platform 630 may include a processing component 640. In addition to, or alternatively of, baseband circuitry 620 of device 600 may execute processing operations or logic for other apparatus, a storage medium, and logic circuit 670 using the processing component 630. Processing component 640 (and/or PHY 626 and/or MAC 628) may comprise various hardware elements, software elements, or a combination of both. Examples of hardware elements may include devices, logic devices, components, processors, microprocessors, circuits, processor circuits (e.g., processor circuit 620), circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 630 may further include other platform components 650. Other platform components 650 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 630 may further include a network interface 660. In some examples, network interface 660 may include logic and/or features to support network interfaces operated in compliance with one or more wireless broadband technologies such as those described in one or more standards associated with IEEE 802.11 such as IEEE 802.11ad.

Device 600 may be, for example, user equipment, a computer, a personal computer (PC), a desktop computer, a laptop computer, a notebook computer, a netbook computer, a tablet computer, other small computing devices, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of device 600 described herein, may be included or omitted in various embodiments of device 600, as suitably desired. In some embodiments, device 600 may be configured to be compatible with protocols and frequencies associated with IEEE 802.11 Standards for WLANs and/or for wireless docking, although the examples are not limited in this respect.

Embodiments of device 600 may be implemented using single input single output (SISO) antenna architectures. However, certain implementations may include multiple antennas (e.g., antennas 618-f) for transmission and/or reception using adaptive antenna techniques for beamforming or spatial division multiple access (SDMA) and/or using multiple input multiple output (MIMO) communication techniques.

The components and features of device 600 may be implemented using any combination of discrete circuitry, application specific integrated circuits (ASICs), logic gates and/or single chip architectures. Further, the features of device 600 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 600 shown in the block diagram of FIG. 6 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled”, “connected”, or “capable of being coupled” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In some examples, a system may include a processor component and memory coupled to the processor component. The system may also include a radio coupled to the processor component and one or more antennas coupled to the radio. The system may also include wireless logic (e.g., logic related to wireless operations) to be executed on the processor component to process reception of a higher-power clear to send (CTS) signal, to set a lower-power transmit opportunity (TXOP), and to process reception of an invitation to share the TXOP at lower power, the invitation comprising an indication that devices that receive the invitation should transmit at lower power during a time period indicated by the higher-power CTS signal. The system may also include a timer to indicate a period of time when the initiator and the initiator's receiver are enabled for lower-power communication.

According to some examples of the system, the wireless logic may further process transmission of a higher-power request to send (RTS) signal prior to process transmission of the higher-power CTS signal.

According to some examples of the system, the higher-power invitation comprising a call for lower-power (CFLP) signal with a desired transmission power level of the lower power data.

According to some examples of the system, the higher-power invitation comprising a self-addressed data packet with a desired transmission power level of the lower power data.

According to some examples of the system, the higher-power invitation comprising a plurality of self-addressed CTS packets with a desired transmission power level of the lower power data.

According to some examples of the system, the higher-power invitation transmitted to a participant that then operates at lower power if the TXOP is not reserved by other devices and if the participant has at least some data to transmit.

According to some examples of the system, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

According to some examples of the system, the higher-power invitation transmitted to a participant that then transmits at lower power a notification of lower power (NOLP) signal to a participant's receiver.

According to some examples of the system, the higher-power invitation transmitted to a participant that receives an acknowledgement from the participant's receiver, the acknowledgement combined with another message.

In some examples, an apparatus may include a processor component and a wireless transceiver to transmit a wireless signal from a computing device. The apparatus may also include wireless logic (e.g., logic related to wireless operations) to be executed on the processor component to process reception of a higher-power clear to send (CTS) signal for transmission from an initiator's receiver, the higher-power CTS signal to set a lower-power transmit opportunity (TXOP), and to process reception of an invitation to share the TXOP at lower power, the invitation comprising an indication that devices that receive the invitation should transmit at lower power during a time period indicated by the higher-power CTS signal. The apparatus may also include a timer to track progress of the time period.

According to some examples of the apparatus, the wireless logic may further process transmission of a higher-power request to send (RTS) signal prior to process reception of the higher-power CTS signal.

According to some examples of the apparatus, the higher-power invitation comprising a call for lower-power (CFLP) signal with a desired transmission power level of the lower power data.

According to some examples of the apparatus, the higher-power invitation comprising a self-addressed data packet with a desired transmission power level of the lower power data.

According to some examples of the apparatus, the higher-power invitation comprising a plurality of self-addressed CTS packets with a desired transmission power level of the lower power data.

According to some examples of the apparatus, the higher-power invitation transmitted to a participant that then operates at lower power if the TXOP is not reserved by other devices and if the participant has at least some data to transmit.

According to some examples of the apparatus, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

According to some examples of the apparatus, the higher-power invitation transmitted to a participant that then transmits at lower power a notification of lower power (NOLP) signal to a participant's receiver.

According to some examples of the apparatus, the higher-power invitation transmitted to a participant that receives an acknowledgement from the participant's receiver, the acknowledgement combined with another message.

In some examples, an example computer-readable storage medium comprises instructions that, when executed, cause a controller to process reception of a higher-power clear to send (CTS) signal from an initiator's receiver, to set a lower-power transmit opportunity (TXOP), and to process reception of an invitation to share the TXOP at lower power, the invitation comprising an indication that devices that receive the invitation should transmit at lower power during a time period indicated by the higher-power CTS signal.

According to some examples of the computer-readable storage medium, the processing component may further process reception of a higher-power request to send (RTS) signal from an initiator prior to process transmission of the higher-power CTS signal.

According to some examples of the computer-readable storage medium, the higher-power invitation comprising a call for lower-power (CFLP) signal with a desired transmission power level of the lower power data.

According to some examples of the computer-readable storage medium, the higher-power invitation comprising a self-addressed data packet with a desired transmission power level of the lower power data.

According to some examples of the computer-readable storage medium, the higher-power invitation comprising a plurality of self-addressed CTS packets with a desired transmission power level of the lower power data.

According to some examples of the computer-readable storage medium, the higher-power invitation transmitted to a participant that then operates at lower power if the TXOP is not reserved by other devices and if the participant has at least some data to transmit.

According to some examples of the computer-readable storage medium, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

According to some examples of the computer-readable storage medium, the higher-power invitation transmitted to a participant that then transmits at lower power a notification of lower power (NOLP) signal to a participant's receiver.

According to some examples of the computer-readable storage medium, the higher-power invitation transmitted to a participant that receives an acknowledgement from the participant's receiver, the acknowledgement combined with another message.

In some examples, an example method may include receiving a higher-power clear to send (CTS) signal from an initiator's receiver, to set a lower-power transmit opportunity (TXOP), and processing an invitation to share the TXOP at lower power, the invitation comprising an indication that devices that receive the invitation should transmit at lower power during a time period indicated by the higher-power CTS signal.

According to some examples of the method, transmitting a higher-power request to send (RTS) signal from an initiator prior to receiving the higher-power CTS signal.

According to some examples of the method, the higher-power invitation comprising a call for lower-power (CFLP) signal with a desired transmission power level of the lower power data.

According to some examples of the method, the higher-power invitation comprising a self-addressed data packet with a desired transmission power level of the lower power data.

According to some examples of the method, the higher-power invitation comprising a plurality of self-addressed CTS packets with a desired transmission power level of the lower power data.

According to some examples of the method, the higher-power invitation transmitted to a participant that then operates at lower power if the TXOP is not reserved by other devices and if the participant has at least some data to transmit.

According to some examples of the method, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

According to some examples of the method, the higher-power invitation transmitted to a participant that then transmits at lower power a notification of lower power (NOLP) signal to a participant's receiver.

According to some examples of the method, the higher-power invitation transmitted to a participant that receives an acknowledgement from the participant's receiver, the acknowledgement combined with another message.

In some examples, an example apparatus may include means for receiving a higher-power clear to send (CTS) signal from an initiator's receiver, to set a lower-power transmit opportunity (TXOP), and means for processing an invitation to share the TXOP at lower power, the invitation comprising an indication that devices that receive the invitation should transmit at lower power during a time period indicated by the higher-power CTS signal.

According to some examples of the apparatus, further comprising means for transmitting a higher-power request to send (RTS) signal prior to transmitting the higher-power CTS signal.

According to some examples of the apparatus, the higher-power invitation comprising a call for lower-power (CFLP) signal with a desired transmission power level of the lower power data.

According to some examples of the apparatus, the higher-power invitation comprising a self-addressed data packet with a desired transmission power level of the lower power data.

According to some examples of the apparatus, the higher-power invitation comprising a plurality of self-addressed CTS packets with a desired transmission power level of the lower power data.

According to some examples of the apparatus, the higher-power invitation transmitted to a participant that then operates at lower power if the TXOP is not reserved by other devices and if the participant has at least some data to transmit.

According to some examples of the apparatus, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

According to some examples of the apparatus, the higher-power invitation transmitted to a participant that then transmits at lower power a notification of lower power (NOLP) signal to a participant's receiver.

According to some examples of the apparatus, the higher-power invitation transmitted to a participant that receives an acknowledgement from the participant's receiver, the acknowledgement combined with another message.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. An apparatus to improve wireless spectral efficiency, comprising:
a wireless transceiver to transmit a wireless signal comprising a higher-power request to send (RTS) signal;
a processing component coupled to the wireless transceiver; and
wireless logic for execution by the processing component to process reception of a higher-power clear to send (CTS) signal from an initiator's receiver, the higher-power CTS signal to set a lower-power transmit opportunity (TXOP), and to process an invitation to share the TXOP at lower power, the invitation to include an indication that a device should transmit at lower power during a time period indicated by the higher-power CTS signal.

2. The apparatus of claim 1, the higher-power invitation comprising one of a call for lower-power (CFLP) signal, a self-addressed data packet, or a plurality of self-addressed CTS packets, each with a desired transmission power level of the lower power data.

3. The apparatus of claim 1, the higher-power invitation transmitted to a participant that then operates at lower power if the TXOP is not reserved by other devices and if the participant has at least some data to transmit.

4. The apparatus of claim 1, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

5. The apparatus of claim 1, the higher-power invitation transmitted to a participant that then transmits at lower power a notification of lower power (NOLP) signal to a participant's receiver.

6. The apparatus of claim 1, the higher-power invitation transmitted to a participant that receives an acknowledgement from the participant's receiver, the acknowledgement combined with another message.

7. A system to improve wireless spectral efficiency, comprising:
a processing component;
memory coupled to the processing component;
a radio coupled to the processing component;
one or more antennas coupled to the radio; and
wireless logic to be executed by the processing component to:
process transmission of a higher-power request to send (RTS) signal;
in response to the higher-power RTS signal, process reception of a higher-power clear to send (CTS) signal from an initiator's receiver to set a lower-power transmit opportunity (TXOP); and
process an invitation to share the TXOP at lower power, the invitation comprising an indication that devices that receive the invitation should transmit at lower power during a time period indicated by the higher-power CTS signal.

8. The system of claim 7, the higher-power invitation comprising one of a call for lower-power (CFLP) signal, a self-addressed data packet, or a plurality of self-addressed CTS packets, each with a desired transmission power level of the lower power data.

9. The system of claim 7, the higher-power invitation transmitted to a participant that then operates at lower power if the TXOP is not reserved by other devices and if the participant has at least some data to transmit.

10. The system of claim 7, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

11. The system of claim 7, the higher-power invitation transmitted to a participant that then transmits at lower power a notification of lower power (NOLP) signal to a participant's receiver.

12. At least one computer-readable storage medium comprising instructions that, when executed, cause a processing component to:
process transmission of a higher-power request to send (RTS) signal;
in response to the higher-power RTS signal, process reception of a higher-power clear to send (CTS) signal from an initiator's receiver, to set a lower-power transmit opportunity (TXOP); and
process an invitation to share the TXOP at lower power, the invitation comprising an indication that devices that receive the invitation should transmit at lower power during a time period indicated by the higher-power CTS signal.

13. The at least one computer-readable storage medium of claim 12, the higher-power invitation comprising one of a call for lower-power (CFLP) signal, a self-addressed data packet, or a plurality of self-addressed CTS packets, each with a desired transmission power level of the lower power data.

14. The at least one computer-readable storage medium of claim 12, the higher-power invitation transmitted to a participant that then operates at lower power if the TXOP is not reserved by other devices and if the participant has at least some data to transmit.

15. The at least one computer-readable storage medium of claim 12, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

16. A method to improve wireless spectral efficiency, comprising:
transmitting a higher-power request to send (RTS) signal;
in response to the higher-power RTS signal, receiving a higher-power clear to send (CTS) signal from an initiator's receiver, to set a lower-power transmit opportunity (TXOP); and
processing an invitation to share the TXOP at lower power, the invitation comprising an indication that devices that receive the invitation should transmit at lower power during a time period indicated by the higher-power CTS signal.

17. The method of claim 16, the higher-power invitation comprising one of a call for lower-power (CFLP) signal, a self-addressed data packet, or a plurality of self-addressed CTS packets, each with a desired transmission power level of the lower power data.

18. The method of claim 16, the higher-power invitation transmitted to a participant that then operates at lower power if the TXOP is not reserved by other devices and if the participant has at least some data to transmit.

19. The method of claim 16, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

20. The method of claim 16, the higher-power invitation transmitted to a participant that then transmits at lower power a notification of lower power (NOLP) signal to a participant's receiver.

21. An apparatus to improve wireless spectral efficiency, comprising:
means for transmitting a higher-power request to send (RTS) signal;
means for responding to the higher-power RTS signal by reception of a higher-power clear to send (CTS) signal from an initiator's receiver, to set a lower-power transmit opportunity (TXOP); and
means for processing an invitation to share the TXOP at lower power, the invitation comprising an indication that devices that receive the invitation should transmit at lower power during a time period indicated by the higher-power CTS signal.

22. The apparatus of claim 21, the higher-power invitation comprising one of a call for lower-power (CFLP) signal, a self-addressed data packet, or a plurality of self-addressed CTS packets, each with a desired transmission power level of the lower power data.

23. The apparatus of claim 21, the higher-power invitation transmitted to a participant that then operates at lower power if the TXOP is not reserved by other devices and if the participant has at least some data to transmit.

24. The apparatus of claim 21, the higher-power invitation transmitted to a plurality of participants that then transmit substantially simultaneously a respective higher-power CTS signal, the higher-power CTS signals substantially identical at a physical networking layer, in order to reserve the TXOP for lower-power operation.

25. The apparatus of claim 21, the higher-power invitation transmitted to a participant that then transmits at lower power a notification of lower power (NOLP) signal to a participant's receiver.
